(19) United States
(12) Patent Application Publication
(10) Pub. No.: US 2005/0124523 A1
(43) Pub. Date: Jun. 9, 2005

(54) Alternative technology for reducing fungi contamination on common building materials and facilities occupied by humans

(76) Inventors: Stephen J. Gorton, Rowlett, TX (US); Peter G. Sollinger, Vero Beach, FL (US)

Correspondence Address: John R. Fantry, 36 Garnet Ridge Rd, Tolland, CT, 06084, US

(21) Appl. No.: 10/731,641

(22) Filed: Dec. 9, 2003

(51) Int. Cl. C12S 9/00

(52) U.S. Cl. 510/392

(57) ABSTRACT

There is a disclosed methods application and use of a specific GRAS-approved enzymes and ingredients combination formulated to prevent and inhibit fingi and their proteins from forming on surface areas of common building materials, and to extend the time period for safer, healthier dwellings, office space, public schools, modular buildings, maritime and aviation equipment, and such, by reducing the known level of fungi and the corresponding exposure level to humans. The enzyme formula is comprised of a combination of safe, plant-and vegetable-based, fungi-derived, non-toxic organic enzymes and catalysts, which works by degrading and neutralizing the offending fungi mycelium, spores and proteins on contact. Our technology is defined as an anti-fungal resistance management technology used to control and remove fungi from common building materials. The unique, proprietary enzyme formulation is applied by identified methods to include standard spray applications, atomization, and/or fuimigation.

### CROSS REFERENCE TO RELATED APPLICATIONS

(none)

### STATEMENT REGARDING FED SPONSORED R&D

(none)

### BACKGROUND OF THE INVENTION

The process of removing fungi and their by-product proteins to make safer dwellings, commercial properties, public schools, and such, is an important issue in many states, including Florida, Texas, California and others. Dollar costs for the health-related illnesses resulting from fungi exposure, including asthma and bronchial infections, are in the billions. Financial losses due to property devaluations pertaining to fungi and mycotoxins, and protein by-products of fungi is a growing concern on numerous fronts, as follow: (1) during the past ten years, pharmaceutical sales for prescriptions to treat asthma-related illness and other lung and upper respiratory diseases has increased five-fold, with annual costs for prescription drugs now exceeding 30 billion dollars; (2) medical and health insurance costs have escalated at twice the rate of inflation during the same period, seriously impacting the profit margins of both small and large business owners; (3) homeowner policies in states such as Texas have risen by forty percent, and mold coverage has been dropped by most carriers; (4) average remediation costs in 2002 for a home in Dallas, Tex., was $45,000; (5) the average time to complete a remediation job is 120 days; (6) insurance companies offering homeowners insurance in the state of Florida are seriously considering dropping mold coverage altogether; (7) in New Jersey, if a homeowner reports an infestation of mold in their property, that damage may be repaired through the insurer, however, the homeowner and the property remediated become black-listed as to future coverage; (8) the clear trend is for insurance companies to drop mold coverage entirely, as has been the experience in Texas; this trend is spreading to other states, compelling homeowners and commercial property owners to self-insure against this costly problem, in which case, many people find themselves without the financial means to deal with the consequences of devaluation and human health risks associated with the contamination.

In a tight commercial real estate market, this translates into a public health concern as remediations are considered quite costly and, as the direct result, many remediation or restoration jobs are delayed, or not scheduled at all, thereby enabling the human health risk to remain in place beyond a reasonable time and perhaps indefinitely, expanding exposure risks for no other reason than lack of immediate financial means at the critical moment. Mold spores continue to germinate and spread via the air handling system(s) and exposure levels to humans increases even more. The ultimate consequence is known as chronic exposure.

The invention has special importance in the remediation and restoration industry. It may be incorporated into a cleaning and remediation program offered by service contractors, building contractors, and remediation/cleaning companies. Without this unique and effective technology, the exposure cycle to fungi will continue.

Property devaluation, financial loss, and potential illness to risk groups, especially including children and the elderly, are an absolute certainty without effective fungi and related protein treatment to clean and remove the harmful substances.

It would be a considerable advantage on all fronts, including occupants, residents, insurers, mortgage lenders, property management firms, realtors, and the like, if these fungi and fungi-derived damaging influences could be eliminated or at least substantially curtailed. Current remediation and restoration technologies, which rely heavily upon older, toxic chemical products, have and continue to deliver less than entirely satisfactory results while introducing additional human health risks of their own. Therefore there is an immediate need for the technology of this invention, which has been developed specifically to address the fungi and allergenic protein concerns noted above.

Numerous laboratories throughout the country, including the University of Florida, INX Laboratories, Inc., of Claremont, Fla., and medical researchers including the Mayo Clinic, have identified several of the offending fungi species of the above noted health concerns. Documentation on known human health risks to extended exposure of certain fungi species is becoming more available to the public. The State of Florida and the University of Florida are both especially interested in this endeavor because the State has one of the largest known mold problems in the country, seriously impacting the health of children, workers, homeowners, the elderly, individuals with compromised immune systems, and such; the mold problem thus has a significant financial impact on insurance companies and their policy decisions relative to whether or not mold coverage is to be included or excluded on future coverage plans.

An additional concern held by many is the looming prospect of mandatory mold inspections, requiring documentation and disclosure prior to transfer of residential real estate, which practice is becoming law in many states, including Florida and California presently, with others presumably to follow shortly thereafter. As a consequence, property values could be lowered and insurability of identified properties could become a concern for both buyer and seller. Lowering property values has a tremendous financial impact on the tax revenues generated for state governments. The State of Florida is deeply concerned. This situation has already been experienced in Texas, where there currently exists 4 billion dollars in losses to the State and individual homeowners. Failures by various building contractors, general contractors, and remediation companies, to successfully remediate many of these properties, has resulted in additional losses through one half billion dollars in lawsuits filed by insurance companies against such contractors and remediators, who had been paid essentially for ineffective work because the products and methodologies they relied upon simply could not produce the desired results on a consistent and reliable basis.

As stated above, any losses related to fungi contamination in living spaces significantly impact the profits anticipated by insurance companies, as well as the tax revenues anticipated by the state governments, which needs those dollars to finance public school operation and state administration.

Awareness of fungal problems is well established in the scientific, medical, real estate, banking and insurance communities, as well as at the homeowner level. Public awareness of such things as a significant increase in childhood asthma and the increased incidence of lower respiratory infections, including bronchial pneumonias, has caused alarm and concern over the condition and safety of buildings and homes relative to possible mold infestation. There is additional public and medical community concern relative to the acknowledged over-prescription of certain antibiotics, steroids, and other drugs used to treat such illnesses.

Traditional mold treatment remedies that have been and continue to be used primarily include: (1) chemical bleach washes and alkaline-based washes; and (2) demolition and reconstruction. Both alternatives are expensive and inconvenient; neither have demonstrated a consistent or reliable capacity to deliver completely satisfactory results, which explains, for example, the Texas lawsuits mentioned earlier. Neither surface wash methodologies nor demolition/reconstruction alternatives are truly capable of rendering a property completely safe and free of fungi. For instance, common problems among remediation contractors resulting in recurrence include failure to remediate the air handling system or the hvac coil, where mold germination occurs. Typically, within weeks or months, the fungi return and once again cause discomfort and illness among those predisposed by age or genetics to be most sensitive.

These ineffective remedies must be replaced by a more effective and safer technology. That is precisely why this invention was formulated. If not completely replacing one of the current technologies, the formulation should at least be used in conjunction with one of the traditional methodologies. In the State of Florida, an estimated two billion dollars will be spent on mold remediation over the next year, and up to five billion will be spent over the next four years in attempts to control this problem. Without the use of this invention, remediation efforts will be less successful and, as Texas experience has demonstrated, much of the work will have to be repeated at additional, and unnecessary expense to the homeowner, insurer, and state government. In the State of Florida, by financial impact, the biggest losers will be the mortgage lenders, the insurers, and the State itself, which loses important tax revenues each time a devalued property is transferred. Additional victims include the half million children in the state suffering from asthma, as well as new homeowners who purchase properties under inadequate inspection conditions.

### SUMMARY OF THE INVENTION

The offending fungi have been identified and include various spores, mycelium and related proteins. Some of these species include, but are not limited to, Aspergillus fumagatis, Aspergillus visicolor and Cladosporium _{and} Penicillium spp. The enzyme-based invention was formulated specifically and exclusively to combat fungi, spores, mycelium and proteins. Product safety and efficacy have been documented by university and laboratory studies, commercial laboratory studies, and by field applications and case studies across the country.

### DETAILED DESCRIPTION OF THE INVENTION

The unique, proprietary formula of the invention is comprised of a combination of safe, non-toxic organic enzymes and catalysts using natural, plant-derived enzymes, and enzymes derived from fungi. This proprietary formulation breaks down polysaccharide cell walls, after which the enzymes destroy and neutralize the protein content of the offending fungi spores, and mycelium as well as any extracellular surface proteins, on contact. This unique technology penetrates porous surfaces through a capillary mode of action and leaves behind an inhibitory surface residue, which protects the building materials from fungal re-growth. This technology provides resistance management against such fingi and their spore germination. The residual inhibition contained in this technology lasts up to one year on treated common building materials.

Prediction modeling, a method to forecast the extended efficacy of the discussed technology on common building materials, has been tested by using the product on known fungi under above average temperature conditions to accelerate growth rates for such fungi. Treatment controls and positive controls using other alternative technologies have been evaluated as well. The formulation continues to work until contiguous substrate sources have been eliminated. The invention used and applied, as described in the following methods and applications steps, is a non-toxic, enzyme-based formulation that neutralizes fungi mycelium, spores and proteins on contact. The technology provides resistance management, a barrier technology on surface areas of common building materials to include numerous types such as wall board, ventilation and air handling surface areas, AC coils, sub flooring, wood, carpeting, sheetrock, and the like.

The method of extending the resistance to fungi growth in places of work and habitation to include residential dwellings, apartments, condominiums, commercial properties, offices, modular buildings, maritime and aviation vessels, and industrial workplaces, is to spray or atomize or surface coat the building materials and related surface areas with the formula explained as follows:

The treatment steps may involve two (2) or more methods.

1. Standard Spray Applications:

An application using a liquid spray, which involves coating surface areas with the liquid enzyme formulation with particles greater than fifteen (15) microns in size to treat infected surface areas and to prevent the occurrence of fungi growth and spore germination.

2. Atomization Fumigation:

The atomization fumigation application of the product involves misting the enzyme formulation with particles of less than fifteen (15) microns in size to treat infected surface areas and to prevent the occurrence of fungi growth and spore germination.

In the above two (2) mentioned and discussed methods of application, it has been found that the condition of building materials, exposed surface areas, and indoor air quality, have been substantially improved as the direct result of the introduction of the invention. It is most likely that the significant improvements attributable to this technology will be measured in consistent and reliable positive changes in indoor air quality, and a corresponding reduction in human health risks and experiences that would otherwise have been recorded through harmful fungi exposure. Numerous indicators will abound, but the simplest and most obvious measure will be the reduction noted in annual pharmaceutical sales data for specific prescriptions such as bronchial dilators, and steroids to treat asthma in children and the elderly.

The above mentioned processes allow for the enzyme-based formula to be applied to areas affected with known fungi, and works to inhibit fungal spore germination and mycelium growth. This technology is to be used to treat multiple types of materials and their surface areas, primarily to manage fungi growth, and limit and inhibit fungi growth on related surface areas.

The unique, proprietary, non-toxic organic enzyme-based formula of this invention may help to protect humans against excessive exposure to potential health risks, which risks they have been and continue to be exposed to on a daily basis in such places as public schools, government offices, places of work, homes and the like, essentially because the facilities have either not been treated with the invention, or have been treated with some inferior alternative remedy.

1. A product comprising a combination of ingredients designed to prevent and inhibit fungal infestation on surface areas of common building materials, and to eliminate and fight such fungi by treating said materials with a liquid formula consisting of safe, non-toxic organic, plant- and vegetable-based, fungi-derived enzymes and catalysts, said product working through a penetrating capillary mode of action, enabling said formulation to be carried beneath the surface area and into the building materials to contact sub-fungi, using natural enzymatic action to break down the polysaccharide cell walls of said fungi mycelium and spores, after which the offending protein content is neutralized by the formula, which action destroys the fungi, mycelium and spores, thereby eliminating any potential for additional spore germination.

2. The process of claim 1, wherein said step of treatment is performed using standard spray application methods with liquid particles greater than fifteen (15) microns being applied to common building materials.

3. The process of claim 1, wherein the step of treatment involves using an atomization or fumigation misting of said common building materials with liquid particle sizes of less than fifteen (15) microns.
